(19) United States
(12) Patent Application Publication
(10) Pub. No.: US 2018/0185122 A1
(43) Pub. Date: Jul. 5, 2018

(54) PERFECTED ORTHODONTIC ATTACHMENT

(71) Applicant: Zamuy Invest, S.L., Barcelona (ES)

(72) Inventor: Arturo Vela Hernandez, Barcelona (ES)

(21) Appl. No.: 15/830,001

(22) Filed: Dec. 4, 2017

(30) Foreign Application Priority Data
Jan. 5, 2017 (ES) P201730012

(51) Int. Cl. A61C 7/28

(52) U.S. Cl. CPC A61C 7/28

(57) ABSTRACT

The invention relates to a perfected orthodontic attachment comprising a base enabled to adhere to a tooth and two perpendicular walls on the base, separated and parallel to each other, and the inner space between them remains open at a size for the insertion of an orthodontic archwire perpendicular to the base, each one of the walls also having an extension in a perpendicular direction to the same and oriented toward the wall, the extensions of each wall in alternating positions with respect to each other and at a distance in relation to the base for the passage and presence of the same orthodontic archwire between the extension and the base.

### RELATED APPLICATION

This application claims the benefit of priority of Spanish Patent Application No. P201730012 filed Jan. 5, 2017, the contents of which are incorporated herein by reference in their entirety.

### FIELD AND BACKGROUND OF THE INVENTION

The object of the present patent application is to register a perfected orthodontic attachment which incorporates notable innovations and advantages over the techniques used hitherto.

More specifically, the invention proposes the development of a perfected orthodontic attachment which, due to the particular arrangement and geometry of the same, facilitates the operation of introducing and positioning the orthodontic archwire or flexible wire commonly used, as well as ensuring and maintaining the correct positioning thereof.

Orthodontic attachments, used for progressively correcting the position of teeth that are poorly aligned with respect to their proper position, are widely known in the current state of the art.

In spite of the positive benefits provided by these attachments in progressively and correctly positioning teeth that are initially in an incorrect position, the operations of the installing said attachments on the dentition of a patient may occasionally be difficult, especially with respect to inserting the orthodontic archwire or flexible wire commonly used for said attachments, as well as to the maintenance of the correct insertion thereof.

This is due to the arrangement of the attachments known in the state of the art, with a tunnel-like tract created by a bridge-type arrangement in the attachment itself, wherein the orthodontic archwire must be inserted.

With such arrangement and geometry known in the state of the art, the orthodontic archwire must be forcefully inserted in lateral direction in relation to the attachment itself and the affected tooth, threaded in said tunnel-like tract.

Such an operation may be especially difficult and complicated for a professional performing said task, given all of the problems it entails.

Moreover, said arrangement described and known in the state of the art does not sufficiently guarantee the maintenance of the insertion of the orthodontic archwire in the intended position in the attachment.

The present invention contributes to solving the present problem, since due to the particular arrangement thereof, it extraordinarily facilitates the operation of introducing and positioning the orthodontic archwire or flexible wire in the commonly used attachment, as well as ensuring and maintaining the correct positioning thereof.

### SUMMARY OF THE INVENTION

The present invention has been developed with the aim of providing a perfected orthodontic attachment comprising a base enabled to adhere to a tooth and two walls arranged on the base, perpendicular or essentially oblique to the same and facing each other in parallel, and with an inner space between them able to be used for the passage and presence of an orthodontic archwire or main wire, and which is essentially characterized by the fact that the walls are separated from one another without direct mutual contact, and the inner space between them is and remains open in a perpendicular direction to the base and with a geometry and proportions that enable the insertion of the orthodontic archwire into said inner space from a vestibular or perpendicular direction to the base; each one of the walls also having an extension in a perpendicular direction to the same and oriented toward the opposite wall and in the region of the wall in contact with its own edge; the extensions of each wall in alternating positions with respect to each other and at a distance in relation to the base to enable the passage and presence of the same orthodontic archwire between the extension and the base.

The perfected orthodontic attachment is preferably made of polyether ether ketone (PEEK) or a similar material.

Alternatively, the perfected orthodontic attachment is made of titanium or a similar material.

The present invention extraordinarily facilitates the operation of introducing and positioning the orthodontic archwire or flexible wire in the commonly used attachment, as well as ensuring and maintaining the correct positioning of the same.

Other characteristics and advantages of the perfected orthodontic attachment will become clear in light of the description of a preferred, though non-exclusive, embodiment, which, by way of a non-limiting example, is illustrated in the accompanying drawings, wherein:

### BRIEF DESCRIPTION OF THE SEVERAL VIEWS OF THE DRAWINGS

FIG. 1 is a schematic perspective view of a preferred embodiment of the perfected orthodontic attachment of the present invention.

FIGS. 2 and 4 are schematic views of a preferred embodiment of the perfected orthodontic attachment of the present invention, also indicating the use thereof.

FIG. 3 is a schematic plan view of a preferred embodiment of the perfected orthodontic attachment of the present invention.

FIG. 5 is a schematic elevation view of a preferred embodiment of the perfected orthodontic attachment of the present invention, also indicating the use thereof.

FIGS. 6 and 7 are schematic plan views, also indicating the use and added advantages of a preferred embodiment of the perfected orthodontic attachment of the present invention.

### DESCRIPTION OF SPECIFIC EMBODIMENTS OF THE INVENTION

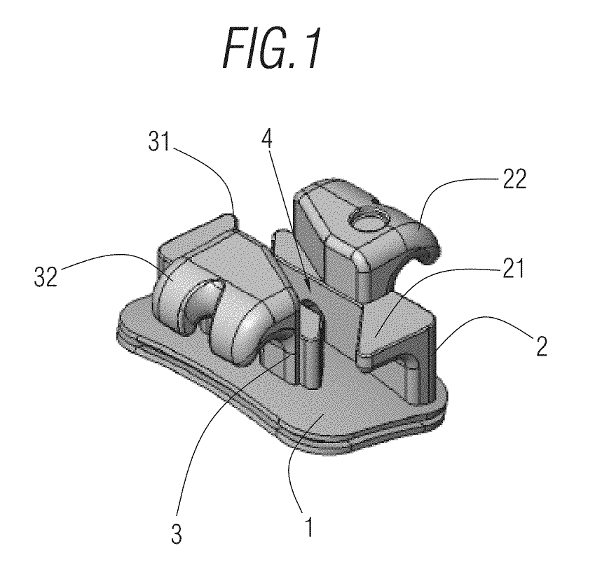

As schematically shown in FIG. 1, the perfected orthodontic attachment of the present invention comprises a base 1 enabled to adhere to a tooth in a way that is already known in the state of the art. On said base 1 there are two walls 2, 3 arranged perpendicularly or essentially oblique with respect to the base 1 itself.

The walls 2, 3 are facing each other and are essentially parallel to one another, and create and limit an inner space 4 between them and the base 1 itself. Said inner space 4 has a breadth and proportions suitable for the passage and presence of an orthodontic archwire 11 or main wire commonly used in these orthodontic attachments known in the state of the art.

The walls 2, 3 of the perfected orthodontic attachment of the present invention are separated from one another without direct mutual contact.

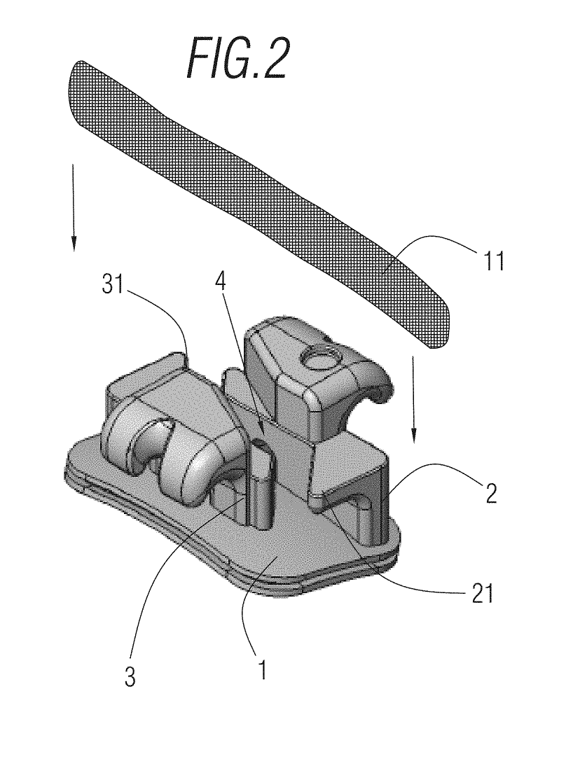

This means that the inner space 4 created and limited between them is and remains open in a perpendicular direction to the base 1, which allows the insertion and introduction of the orthodontic archwire 11 in a vestibular way or from a frontal or perpendicular direction in relation to the base 1 and to the perfected orthodontic attachment of the invention and also in relation to the patient's tooth, as shown by arrows in FIG. 2.

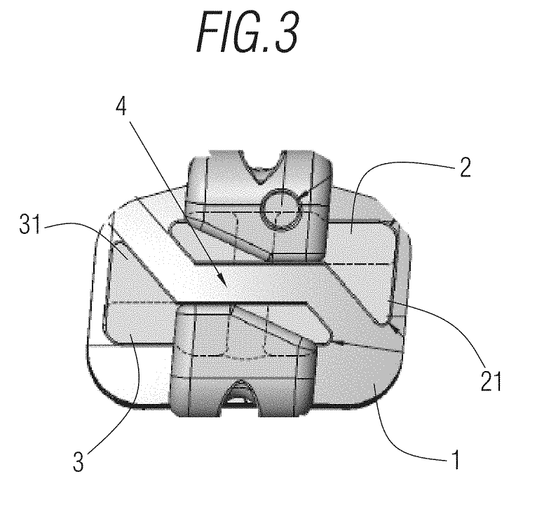

Furthermore, each one of the walls 2, 3 has an extension 21, 31 in a perpendicular direction the same and oriented toward the opposite wall 2, 3 and in the region of the wall 2, 3 in contact with its own lateral edge, as can be seen especially in the plan view in FIG. 3.

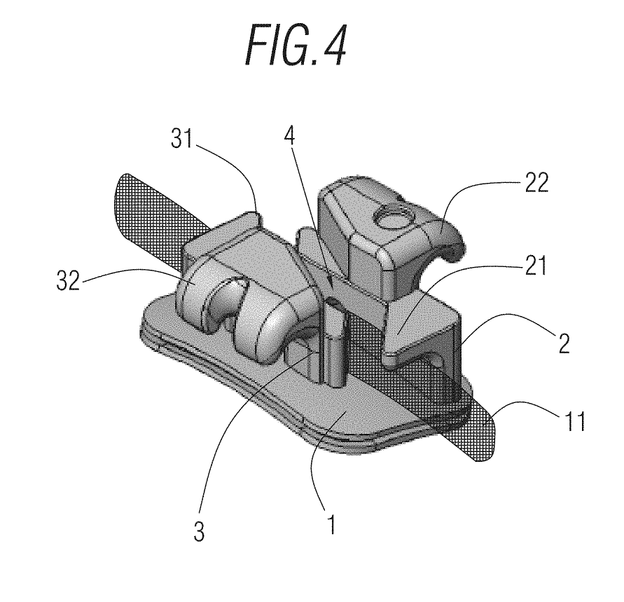

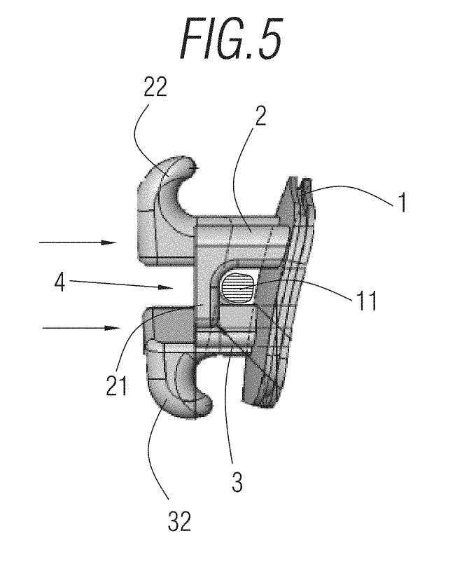

Each one of the extensions 21, 31 of each wall 2, 3 is in an alternate position with respect to the other, as can be seen especially in FIG. 3. The height and distance of said extensions 21, 31 in relation to the base 1 is suitable for the passage and presence of the same orthodontic archwire 11 between the extensions 21, 31 and the base 1, as shown in FIG. 4 and especially in the elevation view in FIG. 5. Also shown in said FIG. 5 by arrows is the direction of the insertion of the orthodontic archwire 11 in the inner space 4 and which also is represented in FIG. 2.

The arrangement explained of the perfected orthodontic attachment of the invention is highly advantageous in relation to the known state of the art. This arrangement of the proposed invention allows the orthodontic archwire 11 to be inserted in a frontal direction to the perfected orthodontic attachment of the invention, and perpendicular to the base 1 thereof and to the very tooth of the patient, as shown by the arrows in FIGS. 2 and 5, extraordinarily facilitating said operation, differing greatly from what has been used up to the present in the state of the art, wherein known orthodontic attachments have an arrangement with walls on the base with direct contact between them in a bridge-type arrangement, making it impossible for the orthodontic archwire to be inserted from the front part of the attachment, unlike the proposed invention, which does allow for such frontal insertion.

With regard to the foregoing, the arrangements known in the state of the art require a lateral threading of the orthodontic archwire 11 through the interior of a tunnel-like tract which becomes enabled between the base and the walls, arranged in a bridge-type arrangement and with direct contact between them, a much more difficult operation for a professional in the field.

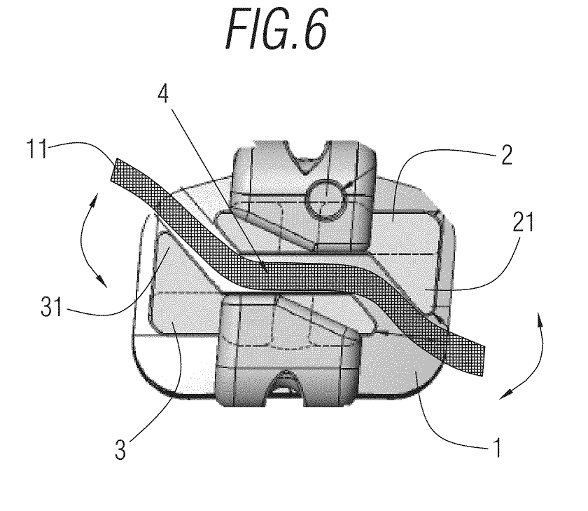

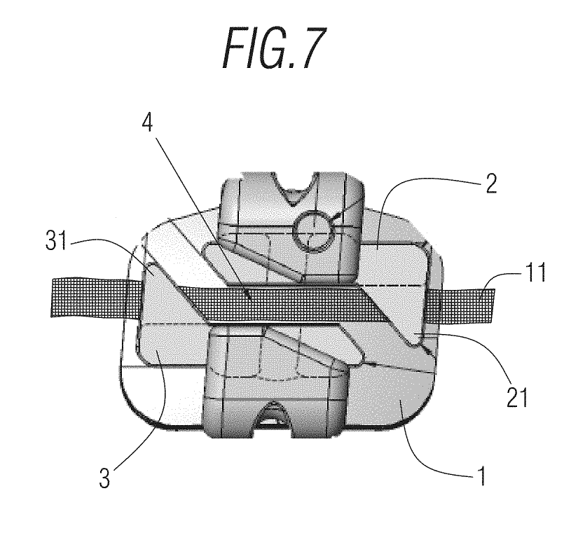

Furthermore, the perfected orthodontic attachment of the invention has other highly significant added advantages. In the front insertion of the orthodontic archwire 11 in a frontal or vestibular direction in the inner space 4, as shown by the arrows in FIGS. 2 and 5, said orthodontic archwire 11 is introduced by slightly turning the same in order to adapt and go around the extensions 21, 31 present on the walls 2, 3 as shown by the arrows in FIG. 6, to thus reach its final position at the end of the inner space 4, as shown in FIGS. 4, 5 and 7, an operation that is very simple for the professional performing such task.

Once the orthodontic archwire 11 is installed in the way previously described, said extensions 21, 31 provide an additional and highly useful benefit in that once the orthodontic archwire 11 is inserted and introduced through the aforementioned operation, represented in FIG. 6, the same orthodontic archwire 11 cannot be extracted or come undone in an unintended or accidental way without a pressure or turn in the opposite direction to that which was initially used in the insertion thereof, as has been referred to and shown in FIG. 6, which must necessarily be a procedure carried out by the professional in the field, and which is clearly a useful property and benefit of the invention.

Furthermore, the described arrangement of the perfected orthodontic attachment of the invention has the advantage of allowing the easy insertion and positioning of the orthodontic archwire 11, which may have any variety of geometry in the cross section thereof, such as circular, square or polygonal.

In a preferred embodiment, the perfected orthodontic attachment of the invention is made of a polyether ether ketone, also known as PEEK, or another similar material.

In another preferred embodiment, the perfected orthodontic attachment of the invention is made of titanium or a similar material.

Similarly to that which is known in the state of the art, the perfected orthodontic attachment of the invention also has the possibility of using elastic tightening means in the same, such as rubber pieces arranged on projections 22, 32 on the walls 2, 3 and enabled for that purpose, in order to further ensure the proper positioning of the orthodontic archwire 11, by tightening the walls 2, 3 through the action of the rubber pieces.

The details, shapes, dimensions and other accessory elements, as well as the materials used to manufacture the perfected orthodontic attachment of the invention, may be suitably substituted for others which are technically equivalent, and do not diverge from the essential nature of the invention, nor the scope defined by the claims included below.

What is claimed is:

1. A perfected orthodontic attachment comprising a base (1) enabled to adhere to a tooth and two walls (2, 3) arranged on the base (1), perpendicular or essentially oblique to the same and facing each other in parallel, and with an inner space (4) between them enabled to be used for the passage and presence of an orthodontic archwire (11) or main wire, characterized in that the walls (2, 3) are separated from one another without direct mutual contact and the inner space (4) between them is and remains open in a perpendicular direction to the base (1) and with a geometry and proportions that enable the insertion of the orthodontic archwire (11) into said inner space (4) from a vestibular or perpendicular direction to the base (1); each one of the walls (2, 3) also having an extension (21, 31) in a perpendicular direction to the same and oriented toward the opposite wall (2, 3) and in the region of the wall (2, 3) in contact with its own edge; the extensions (21, 31) of each wall (2, 3) in alternating positions with respect to each other and at a distance in relation to the base (1) to enable the passage and presence of the same orthodontic archwire (11) between the extension (21, 31) and the base (1).

2. The perfected orthodontic attachment according to claim 1, characterized in that it is made of polyether ether ketone (PEEK) or a similar material.

3. The perfected orthodontic attachment according to claim 1, characterized in that it is made of titanium or a similar material.
